(19) United States
(12) Patent Application Publication
(10) Pub. No.: US 2018/0302512 A1
(43) Pub. Date: Oct. 18, 2018

(54) PERSONALIZED CALL HOLD CONTENT

(71) Applicant: Daniel T. Hamling, Oceanside, CA (US)

(72) Inventor: Daniel T. Hamling, Oceanside, CA (US)

(21) Appl. No.: 15/953,372

(22) Filed: Apr. 13, 2018

Related U.S. Application Data
(60) Provisional application No. 62/485,507, filed on Apr. 14, 2017.

(51) Int. Cl. H04M 3/428

(52) U.S. Cl. CPC H04M 3/4285; H04M 3/42059

(57) ABSTRACT

Techniques are presented for delivering high quality personalized call hold media content that is selected from multiple sources. Specifically, the techniques apply a rule base to a set of caller attributes to select personalized media content to deliver to a caller on hold, thereby improving the quality and choice of media content delivered to the caller. For a particular call between a caller on a user device and another call participant, a hold event associated with the call is detected. A set of hold content rules are applied to various caller attributes to select a set of media content to deliver to the caller's user device. The media content is selected from local content available at the user device (e.g., music owned by the caller) and/or remote content external to the user device (e.g., personalized ads for the caller).

### RELATED APPLICATIONS

This present application claims the benefit of priority to co-pending U.S. Patent Application Ser. No. 62/485,507, titled “PERSONALIZED CALL HOLD CONTENT” (Attorney Docket No. DTH-P0005-00-US), filed Apr. 14, 2017, which is hereby incorporated by reference in its entirety.

### FIELD

This disclosure relates to media content management, and more particularly to techniques for delivery of personalized call hold content.

### BACKGROUND

High volume call servicing has evolved to include some form of interaction between the caller and a non-human entity. For example, calls placed to many customer service numbers are often answered by an automated attendant that can provide certain information, collection certain information, direct the calls, and/or perform other operations, without human intervention. Such automated attendants might be configured in a call processing application on a call server that interfaces with the telecommunications network (e.g., PSTN, WAN, etc.). In certain cases, such as when waiting for a human customer service representative to become available, the automated attendant can place the caller on hold.

Unfortunately, the quality and choice of the media content presented to the caller during the hold can be deficient. In many cases, the caller experience can be negatively impacted by the content provided. Specifically, some approaches to delivering hold content merely select from a pre-determined playlist of music accessible by the call processing application. In such cases, the genre of the music selected is often not preferred by the caller. Further, the quality of the audio delivered to the caller's user device (e.g., smart phone) can be poor, at least as compared to the quality the caller might experience using other native or streaming audio applications. Other approaches might further deliver certain informational content and/or advertising content to the caller during the hold period. However, the content delivered using such approaches is often fixed (e.g., not personalized). A technological solution is therefore needed to deliver high quality, personalized media content to a caller that is on hold.

What is needed is a technique or techniques to improve over legacy techniques and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for personalized call hold content, which techniques advance the relevant technologies to address technological issues with legacy approaches. More specifically, the present disclosure provides a detailed description of techniques used in systems, methods, and in computer program products for delivering high quality personalized call hold media content selected from multiple sources. Certain embodiments are directed to technological solutions for applying a rule base to a set of caller attributes to select personalized media content to deliver to a caller on hold.

The disclosed embodiments modify and improve over legacy approaches. In particular, the herein-disclosed techniques provide technical solutions that address the technical problems attendant to the quality and choice of media content delivered to a caller that is on hold. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of personalized content distribution as well as advances in various technical fields related to media content management.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A and FIG. 1B illustrate computing environments in which embodiments of the present disclosure can be implemented.

FIG. 2 depicts a call hold processing technique as implemented in systems that facilitate delivery of high quality personalized call hold media content selected from multiple sources, according to an embodiment.

FIG. 3 presents an interaction diagram showing a call hold processing scenario as implemented in systems that facilitate delivery of high quality personalized call hold media content selected from multiple sources, according to some embodiments.

FIG. 4 depicts system components as arrangements of computing modules that are interconnected so as to implement certain of the herein-disclosed embodiments.

FIG. 5 presents a block diagram of a computer system architecture having components suitable for implementing embodiments of the present disclosure, and/or for use in the herein-described environments.

### DETAILED DESCRIPTION

Embodiments in accordance with the present disclosure address the problem of the quality and choice of media content delivered to a caller that is on hold. Some embodiments are directed to approaches for applying a rule base to a set of caller attributes to select personalized media content to deliver to a caller on hold. The accompanying figures and discussions herein present example environments, systems, methods, and computer program products for delivering high quality personalized call hold media content selected from multiple sources.

### Overview

Disclosed herein are techniques for applying a rule base to a set of caller attributes to select personalized media content to deliver to a caller on hold. In certain embodiments, a call between a caller on a user device and another call participant is identified. At some moment in time, a hold event associated with the call is detected. Various caller attributes are received, and a set of hold content rules are applied to the attributes to determine a set of media content to deliver to the caller's user device. In certain embodiments, the media content might be sourced from the user device (e.g., caller-owned music). In certain embodiments, permission from the caller might be requested before delivering some or all of the media content. In certain embodiments, the media content is delivered from one or more content providers over a network.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

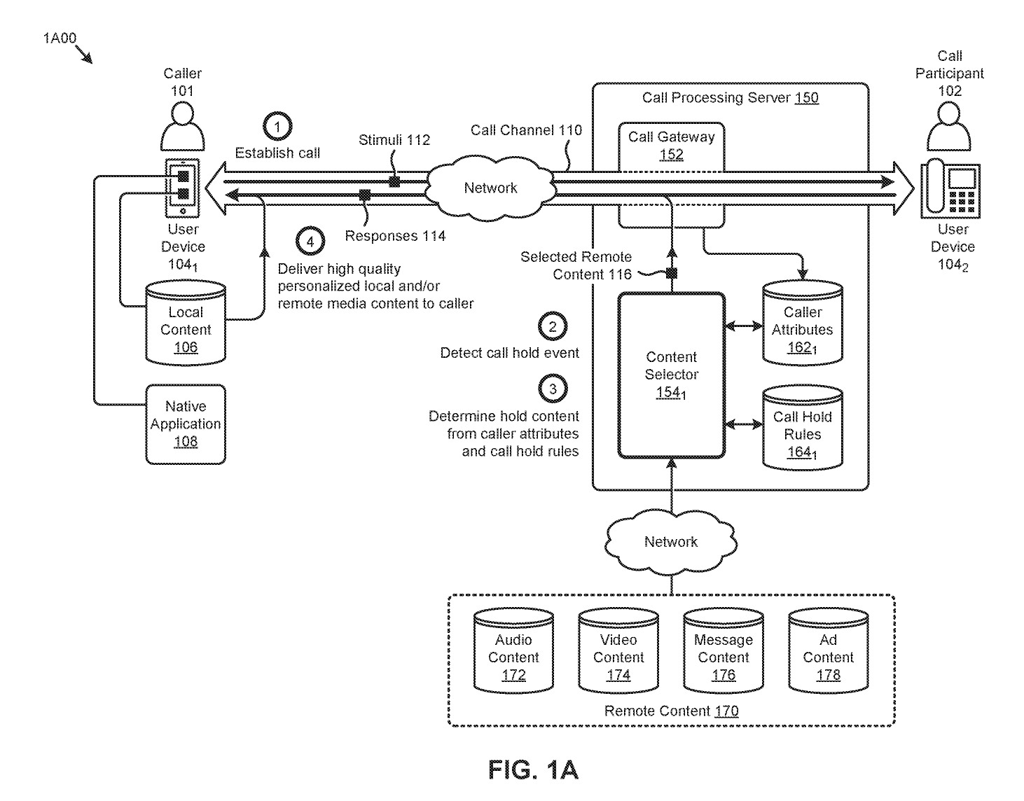

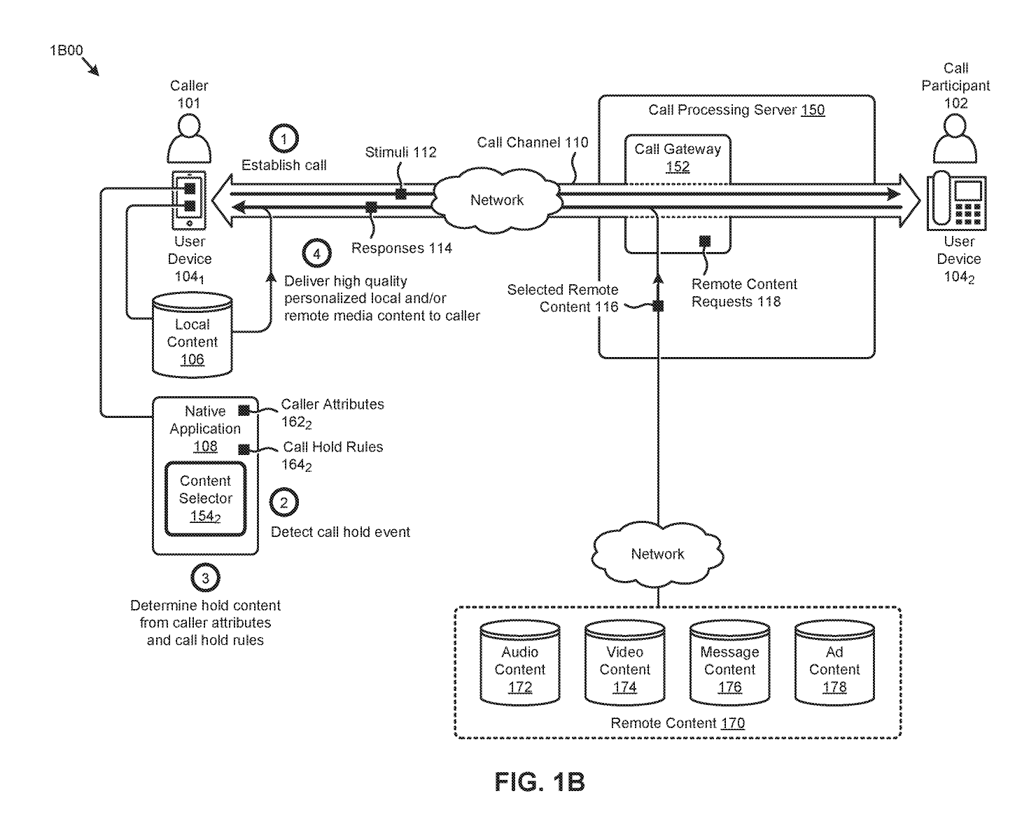

FIG. 1A and FIG. 1B illustrate a first computing environment 1A00 and a second computing environment 1B00, respectively, in which embodiments of the present disclosure can be implemented. As an option, one or more variations of the computing environments or any aspect thereof may be implemented in the context of the architecture and functionality of the embodiments described herein. The components, data structures, and data flows shown in first computing environment 1A00 and second computing environment 1B00 are merely exemplary examples, and other subsystems, components, data structures, and/or partitioning for implementing the herein disclosed techniques are reasonable.

As can be observed in FIG. 1A, first computing environment 1A00 comprises a call processing server 150 that includes a call gateway 152. A call between a caller 101 and a call participant 102 is established over a call channel 110 (operation 1). For example, caller 101 might be a bank customer calling the bank for information or customer service. In this case, call participant 102 might be a customer service representative (e.g., a person) or an automated response service (e.g., a non-human) associated with the bank. The call channel 110 might be facilitated by a circuit-switched connection (e.g., with PSTN), a packet-switched connection (e.g., with VOIP), another type of connection, and/or any combination thereof. The call gateway 152 accesses the call channel 110 to receive, over a network (e.g., wireless and/or wired network), various instances of stimuli 112 (e.g., spoken word, touchpad entries, etc.) from a user device 104₁ of caller 101, and deliver certain responses 114 (e.g., from a user device 104₂ of call participant 102) to user device 104₁. Certain instances of caller attributes 162₁ (e.g., device information, caller information, etc.) might also be extracted from the stimuli 112 detected at call gateway 152. In some cases, caller 101 might interact with a native application 108 (e.g., an app provided the bank) at user device 104₁ to establish at least a portion of the caller attributes 162₁ (e.g., user preferences, user permissions, etc.).

When the call goes on hold, the herein disclosed techniques can facilitate delivery of high quality personalized call hold media content to caller 101 at user device 104₁. Specifically, a content selector 154₁ at call processing server 150 can detect the call hold event (operation 2). A set of call hold rules 164₁ are applied to some or all of the caller attributes 162₁ to determine a set of call hold content to deliver to the caller (operation 3). Such call hold content might be selected from a set of local content 106 at user device 104₁, a set of remote content 170 (e.g., audio content 172, video content 174, message content 176, ad content 178, etc.), and/or other content sources. For example, certain caller preferences described in caller attributes 162₁ might indicate that caller 101 desires to hear hold music selected from local content 106 (e.g., audio files) on user device 104₁. Since the local content 106 is native to user device 104₁, it can be characterized as both high quality and personalized. Other caller attributes might indicate a permission to deliver advertisements (e.g., from ad content 178 in remote content 170). In this case, as an example, other caller attributes (e.g., personally identifiable information, non-personally identifiable information, etc.) can be used to select caller-specific personalized ads to include in the selected remote content 116 delivered to caller 101. In any case, the herein disclosed techniques deliver high quality personalized local and/or remote media content to the caller (operation 4).

Referring to FIG. 1B, second computing environment 1B00 depicts a content selector 154₂ in a native application 108 operating at a user device 104₁ of a caller 101. In this case, a call between caller 101 on user device 104₁ and a call participant 102 at a user device 104₂ that is established over a call channel 110 (operation 1) is accessed by a call gateway 152 at a call processing server 150. Specifically, call gateway 152 accesses the call channel 110 to receive, over a network (e.g., wireless and/or wired network), various instances of stimuli 112 from user device 104₁ of caller 101, and deliver certain responses 114 to user device 104₁.

When the call goes on hold, the herein disclosed techniques can facilitate delivery of high quality personalized call hold media content to caller 101 at user device 104₁. Specifically, content selector 154₂ at native application 108 can detect the call hold event (operation 2). A set of call hold rules 164₂ are applied by content selector 154₂ to one or more caller attributes 162₂ to determine a set of call hold content to deliver to the caller (operation 3). Such call hold content might be selected from the local content 106 at user device 104₁, a set of remote content 170 (e.g., audio content 172, video content 174, message content 176, ad content 178, etc.), and/or other content sources. For example, certain caller attributes might indicate a permission to deliver advertisements (e.g., from ad content 178 in remote content 170). In this case, as an example, other caller attributes (e.g., personally identifiable information, non-personally identifiable information, etc.) can be encoded in various instances of remote content requests 118 issued from native application 108 to call gateway 152. The call gateway 152 can process the remote content requests 118 to deliver the selected remote content 116 (e.g., personalized ads) to caller 101 at user device 104₁. In any case, the herein disclosed techniques deliver high quality personalized local and/or remote media content to the caller (operation 4).

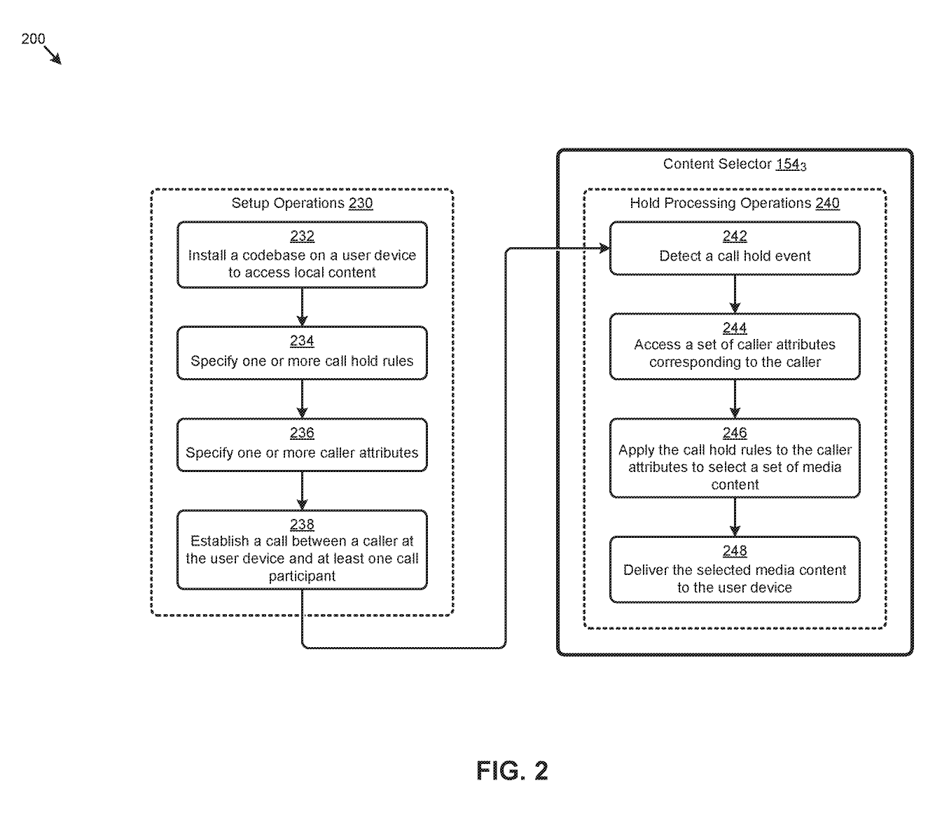

FIG. 2 depicts a call hold processing technique 200 as implemented in systems that facilitate delivery of high quality personalized call hold media content selected from multiple sources. As an option, one or more variations of call hold processing technique 200 or any aspect thereof may be implemented in the context of the architecture and functionality of the embodiments described herein. The call hold processing technique 200 or any aspect thereof may be implemented in any environment.

The call hold processing technique 200 presents one embodiment of certain steps and/or operations that facilitate delivery of high quality personalized call hold media content selected from multiple sources. As shown, the steps and/or operations can be grouped in a set of setup operations 230 and a set of hold processing operations 240. In certain embodiments, at least some of these operations (e.g., hold processing operations 240) can be performed by an instance of a content selector 154₃ (e.g., at a call processing server, a native application, etc.). As illustrated, the setup operations 230 of the call hold processing technique 200 can commence by installing a codebase on a user device to access the local content of the device (step 232). For example, the codebase might be included in a mobile application (e.g., native application) provided by an enterprise (e.g., a bank, the IRS, etc.) that receives customer service calls which are put on hold from time to time. A set of call hold rules are specified (step 234). For example, a system administrator of the enterprise might store a set of call hold rules for access by the content selector 154₃. A set of caller attributes are also specified (step 236). For example, the aforementioned codebase in the mobile application might provide a user interface to facilitate a user (e.g., a caller) to specify certain attributes pertaining to the user. Specifically, the caller attributes might describe certain preferences associated with call hold content (e.g., “local_music=true”, “personalized_ads=false”, “info_messages=false”, “view_slideshow=true”, etc.). In some cases, certain caller attributes can be generated and/or detected in real time when a call between the caller and a call participant is established (step 238). For example, these real time caller attributes might include non-personally identifiable information (NPII), such as a device identifier for the user device, or might include personally identifiable information (PII), such as the name of a registered user (e.g., caller) logged into the mobile application.

The hold processing operations 240 shown in FIG. 2 can commence by detecting a call hold event (step 242). For example, a call hold event might be detected at content selector 154₃ upon receiving a signal issued in response to a change in call status (e.g., from an “Active” status to a “Hold” status). Any caller attributes (e.g., persistent caller attributes, dynamic caller attributes, etc.) corresponding to the caller are accessed (step 244). The call hold rules are applied to the caller attributes to select a set of media content (step 246). For example, a preference to hear local (e.g., from the user device) hold music described in the caller attributes (e.g., preferences) can be applied to a hold music selection rule to invoke the playing of a song and/or playlist on the user device. The selected media content is often selected from multiple content sources accessible over a network (e.g., the Internet, LAN, WAN, WLAN, etc.). When the media content is selected, it is then delivered to the user device (step 248).

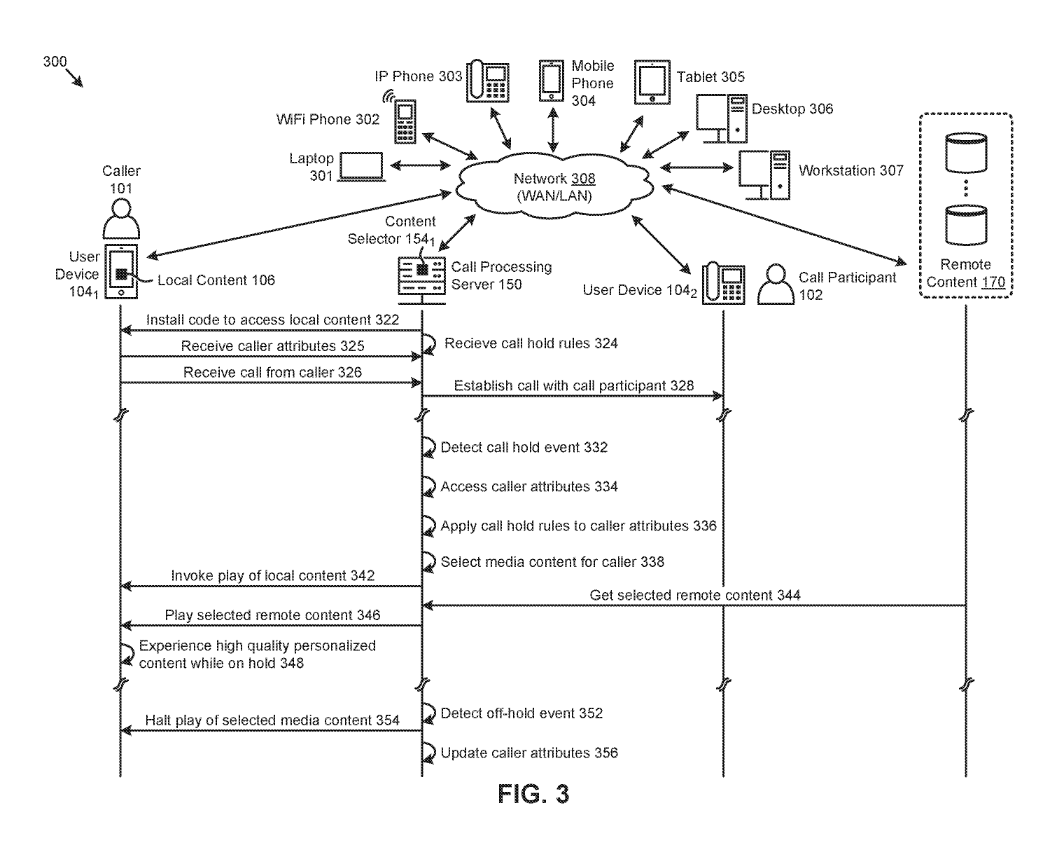

FIG. 3 presents an interaction diagram showing a call hold processing scenario 300 as implemented in systems that facilitate delivery of high quality personalized call hold media content selected from multiple sources. As an option, one or more variations of call hold processing scenario 300 or any aspect thereof may be implemented in the context of the architecture and functionality of the embodiments described herein. The call hold processing scenario 300 or any aspect thereof may be implemented in any environment.

The interaction diagram of FIG. 3 presents interactions between various computing system entities (e.g., servers, devices, sources, applications, etc.) to carry out the call hold processing scenario 300 according to the herein disclosed techniques. The shown entities can communicate information (e.g., data, files, objects, messages, requests, data downloads, data uploads, etc.) over a network 308 comprising any combination of a wide area network (e.g., WAN), local area network (e.g., LAN), cellular network, wireless LAN (e.g., WLAN), the Internet, and/or any such capability for facilitating communication in computing systems and entities. As shown, the entities interacting in FIG. 3 comprise a user device 104₁ operated by a caller 101, at least one instance of the call processing server 150, a user device 104₂ operated by a call participant 102, and a set of remote content 170. As further shown, an instance of the content selector 154₁ is implemented in the call processing server 150. A set of local content 106 at the user device is also depicted. The shown user devices can represent one of a variety of other computing devices (e.g., a laptop 301, a WiFi phone 302, an IP phone 303, a mobile phone 304, a tablet 305, a desktop 306, a workstation 307, etc.) having software (e.g., operating system, applications, etc.) and hardware (e.g., a graphics processing unit, display, monitor, etc.) capable of processing and presenting visual information (e.g., web page, graphical user interface, video, picture, etc.) and/or audio information (e.g., voice, music, sounds, etc.) and/or other information.

As shown in the embodiment of FIG. 3, the user device 104₁, the call processing server 150, the user device 104₂, and the storage devices storing the remote content 170 can exhibit a set of high order interactions (e.g., operations, messages, etc.). Specifically, a set of code (e.g., a native application) is downloaded from the call processing server and installed on user device 104₁ (message 322). Various call hold rules are received at call processing server 150 (operation 324). Caller attributes are also received at call processing server 150 from user device 104₁ (message 325). The call processing server 150 also receives a call from caller 101 (message 326) and connects the call to call participant 102 (message 328).

At some later moment in time, a call hold event is detected (operation 332). Any available caller attributes are accessed (operation 334) to facilitate applying the call hold rules to the caller attributes (operation 336). Based on the results generated from the foregoing operations, a set of media content for the caller is selected (operation 338). As one example, the selected media content might comprise at least a portion of the local content 106 at user device 104₁ of caller 101. In this case, call processing server 150 invokes the play of certain portions (e.g., song or playlist) of local content 106 at user device 104₁ (message 342). The call processing server 150 might also retrieve certain selections of remote content 170 based on the media content selection (message 344) and deliver the selected remote content to user device 104₁ of the caller (message 346). For example, certain personalized audio and/or video ads might be delivered to caller 101 while caller's favorite playlist is heard in the background. The result of selecting and delivering the local and/or remote content as described herein is that the caller experiences high quality personalized content while on hold (operation 348).

At some later moment in time, an off-hold event is detected (operation 352). The play of the selected content at the caller's user device is halted (message 354). In some cases, the caller attributes at call processing server 150 are updated (operation 356). For example, the call attributes might be updated to store local audio playback information comprising a playback point in a playlist that can be referenced as a starting point for playback in a later hold period.

The foregoing call hold processing scenario is merely one example of the use of the herein disclosed techniques to deliver high quality personalized call hold media content selected from multiple sources, and other scenarios and uses are possible.

### Additional Embodiments of the Disclosure

### Additional Practical Application Examples

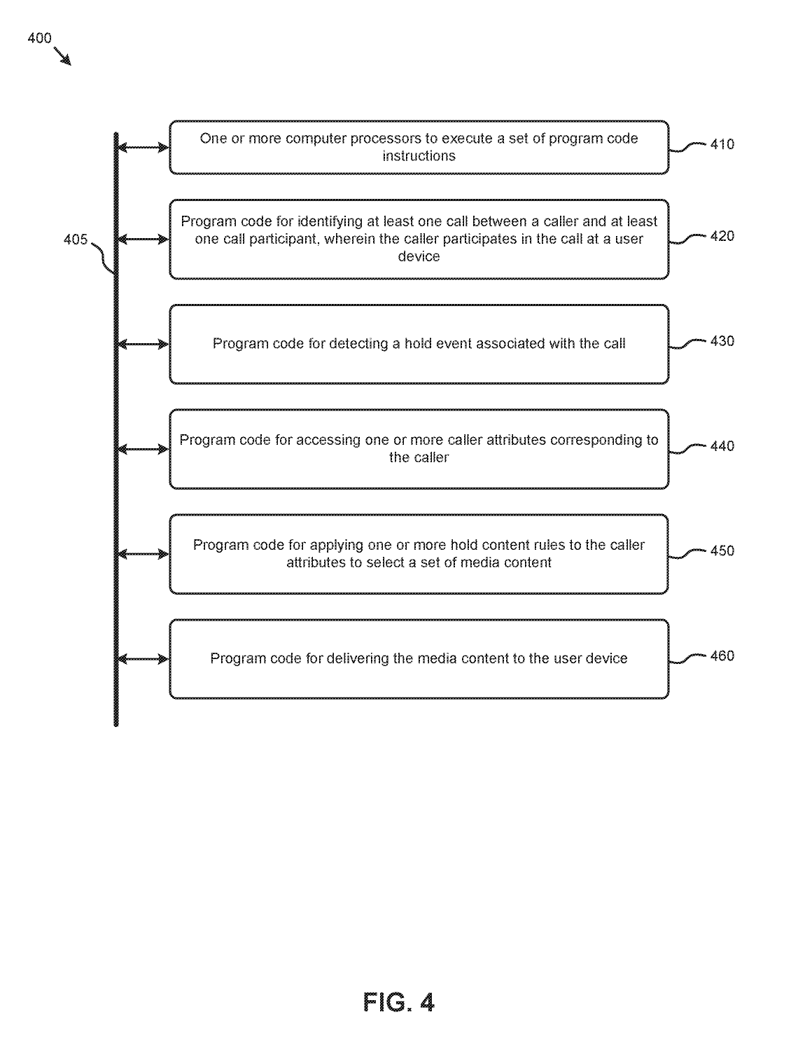

FIG. 4 depicts a system 400 as an arrangement of computing modules that are interconnected so as to operate cooperatively to implement certain of the herein-disclosed embodiments. This and other embodiments present particular arrangements of elements that, individually and/or as combined, serve to form improved technological processes that address the quality and choice of media content delivered to a caller that is on hold. The partitioning of system 400 is merely illustrative and other partitions are possible.

Variations of the foregoing may include more or fewer of the shown modules. Certain variations may perform more or fewer (or different) steps, and/or certain variations may use data elements in more, or in fewer (or different) operations. As an option, the system 400 may be implemented in the context of the architecture and functionality of the embodiments described herein. Of course, however, the system 400 or any operation therein may be carried out in any desired environment. The system 400 comprises at least one processor and at least one memory, the memory serving to store program instructions corresponding to the operations of the system. As shown, an operation can be implemented in whole or in part using program instructions accessible by a module. The modules are connected to a communication path 405, and any operation can communicate with other operations over communication path 405. The modules of the system can, individually or in combination, perform method operations within system 400. Any operations performed within system 400 may be performed in any order unless as may be specified in the claims. The shown embodiment implements a portion of a computer system, presented as system 400, comprising a computer processor to execute a set of program code instructions (module 410) and modules for accessing memory to hold program code instructions to perform: identifying at least one call between a caller and at least one call participant, wherein the caller participates in the call at a user device (module 420); detecting a hold event associated with the call (module 430); accessing one or more caller attributes corresponding to the caller (module 440); applying one or more hold content rules to the caller attributes to select a set of media content (module 450); and deliver the media content to the user device (module 460).

### System Architecture Overview

### Additional System Architecture Examples

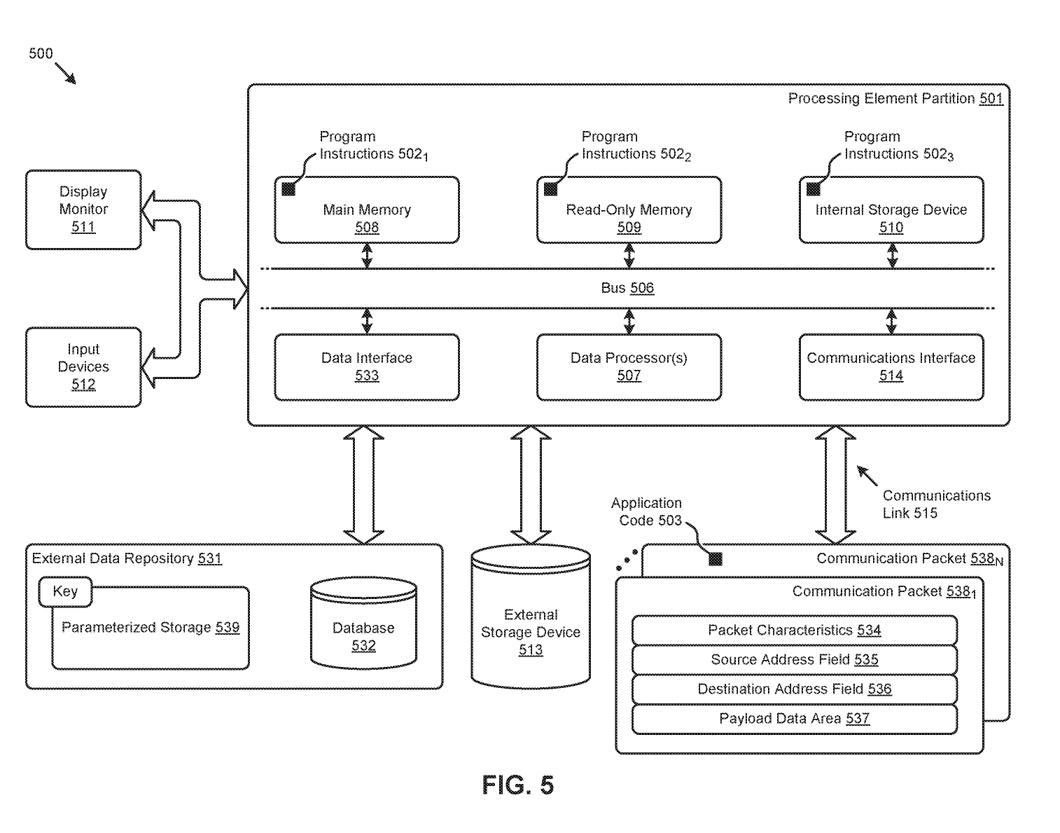

FIG. 5 depicts a block diagram of an instance of a computer system 500 suitable for implementing embodiments of the present disclosure. Computer system 500 includes a bus 506 or other communication mechanism for communicating information. The bus interconnects subsystems and devices such as a central processing unit (CPU), or a multi-core CPU (e.g., data processor 507), a system memory (e.g., main memory 508, or an area of random access memory (RAM)), a non-volatile storage device or non-volatile storage area (e.g., read-only memory 509), an internal storage device 510 or external storage device 513 (e.g., magnetic or optical), a data interface 533, a communications interface 514 (e.g., PHY, MAC, Ethernet interface, modem, etc.). The aforementioned components are shown within processing element partition 501, however other partitions are possible. The shown computer system 500 further comprises a display 511 (e.g., CRT or LCD), various input devices 512 (e.g., keyboard, cursor control), and an external data repository 531.

According to an embodiment of the disclosure, computer system 500 performs specific operations by data processor 507 executing one or more sequences of one or more program code instructions contained in a memory. Such instructions (e.g., program instructions 502₁, program instructions 502₂, program instructions 502₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 500 performs specific networking operations using one or more instances of communications interface 514. Instances of the communications interface 514 may comprise one or more networking ports that are configurable (e.g., pertaining to speed, protocol, physical layer characteristics, media access characteristics, etc.) and any particular instance of the communications interface 514 or port thereto can be configured differently from any other particular instance. Portions of a communication protocol can be carried out in whole or in part by any instance of the communications interface 514, and data (e.g., packets, data structures, bit fields, etc.) can be positioned in storage locations within communications interface 514, or within system memory, and such data can be accessed (e.g., using random access addressing, or using direct memory access DMA, etc.) by devices such as data processor 507.

The communications link 515 can be configured to transmit (e.g., send, receive, signal, etc.) any types of communication packets (e.g., communication packet 538₁, . . . , communication packet 538_{N}) comprising any organization of data items. The data items can comprise a payload data area 537, a destination address 536 (e.g., a destination IP address), a source address 535 (e.g., a source IP address), and can include various encodings or formatting of bit fields to populate the shown packet characteristics 534. In some cases the packet characteristics include a version identifier, a packet or payload length, a traffic class, a flow label, etc. In some cases the payload data area 537 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 507 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 531, which in turn can be formatted into any one or more storage areas, and which can comprise parameterized storage 539 accessible by a key (e.g., filename, table name, block address, offset address, etc.).

Execution of the sequences of instructions to practice certain embodiments of the disclosure are performed by a single instance of the computer system 500. According to certain embodiments of the disclosure, two or more instances of computer system 500 coupled by a communications link 515 (e.g., LAN, PTSN, or wireless network) may perform the sequence of instructions required to practice embodiments of the disclosure using two or more instances of components of computer system 500.

The computer system 500 may transmit and receive messages such as data and/or instructions organized into a data structure (e.g., communications packets). The data structure can include program instructions (e.g., application code 503), communicated through communications link 515 and communications interface 514. Received program code may be executed by data processor 507 as it is received and/or stored in the shown storage device or in or upon any other non-volatile storage for later execution. Computer system 500 may communicate through a data interface 533 to a database 532 on an external data repository 531. Data items in a database can be accessed using a primary key (e.g., a relational database primary key).

The processing element partition 501 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 507. Some embodiments include one or more special-purpose hardware components (e.g., power control, logic, sensors, transducers, etc.). Some embodiments of a module include instructions that are stored in a memory for execution so as to implement algorithms that facilitate operational and/or performance characteristics pertaining to delivering high quality personalized call hold media content selected from multiple sources. A module may include one or more state machines and/or combinational logic used to implement or facilitate the operational and/or performance characteristics pertaining to delivering high quality personalized call hold media content selected from multiple sources.

Various implementations of the database 532 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of delivering high quality personalized call hold media content selected from multiple sources). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to delivering high quality personalized call hold media content selected from multiple sources, and/or for improving the way data is manipulated when performing computerized operations pertaining to applying a rule base to a set of caller attributes to select personalized media content to deliver to a caller on hold.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for delivery of personalized call hold content, the method comprising:
identifying at least one call between a caller and at least one call participant, wherein the caller participates in the call at a user device;
detecting a hold event associated with the call;
accessing one or more caller attributes corresponding to the caller;
applying one or more hold content rules to the caller attributes to select a set of media content; and
delivering the set of media content to the user device.

2. The method of claim 1, wherein at least a portion of the set of media content is stored on the user device.

3. The method of claim 2, wherein the portion of the set of media content from the user device comprises one or more audio files.

4. The method of claim 1, further comprising requesting permission from the caller to deliver at least a portion of the set of media content to the user device.

5. The method of claim 1, wherein the set of media content is delivered from one or more content providers over a network.

6. The method of claim 1, wherein the set of media content comprises at least one of, a set of audio content, a set of video content, a set of ad content, or a set of message content.

7. The method of claim 1, wherein the caller attributes characterize at least one of, one or more caller preferences, a set of non-personally identifiable information, a set of personally identifiable information, or a set of local audio playback information.

8. A computer readable medium, embodied in a non-transitory computer readable medium, the non-transitory computer readable medium having stored thereon a sequence of instructions which, when stored in memory and executed by one or more processors causes the one or more processors to perform a set of acts for delivery of personalized call hold content, the set of acts comprising:
identifying at least one call between a caller and at least one call participant, wherein the caller participates in the call at a user device;
detecting a hold event associated with the call;
accessing one or more caller attributes corresponding to the caller;
applying one or more hold content rules to the caller attributes to select a set of media content; and
delivering the set of media content to the user device.

9. The computer readable medium of claim 8, wherein at least a portion of the set of media content is stored on the user device.

10. The computer readable medium of claim 9, wherein the portion of the set of media content from the user device comprises one or more audio files.

11. The computer readable medium of claim 8, further comprising instructions which, when stored in memory and executed by the one or more processors causes the one or more processors to perform acts of requesting permission from the caller to deliver at least a portion of the set of media content to the user device.

12. The computer readable medium of claim 8, wherein the set of media content is delivered from one or more content providers over a network.

13. The computer readable medium of claim 8, wherein the set of media content comprises at least one of, a set of audio content, a set of video content, a set of ad content, or a set of message content.

14. The computer readable medium of claim 8, wherein the caller attributes characterize at least one of, one or more caller preferences, a set of non-personally identifiable information, a set of personally identifiable information, or a set of local audio playback information.

15. A system for delivery of personalized call hold content, the system comprising:
a storage medium having stored thereon a sequence of instructions; and
one or more processors that execute the sequence of instructions to cause the one or more processors to perform a set of acts, the set of acts comprising,
identifying at least one call between a caller and at least one call participant, wherein the caller participates in the call at a user device;
detecting a hold event associated with the call;
accessing one or more caller attributes corresponding to the caller;
applying one or more hold content rules to the caller attributes to select a set of media content; and
delivering the set of media content to the user device.

16. The system of claim 15, wherein at least a portion of the set of media content is stored on the user device.

17. The system of claim 16, wherein the portion of the set of media content from the user device comprises one or more audio files.

18. The system of claim 15, wherein the set of media content is delivered from one or more content providers over a network.

19. The system of claim 15, wherein the set of media content comprises at least one of, a set of audio content, a set of video content, a set of ad content, or a set of message content.

20. The system of claim 15, wherein the caller attributes characterize at least one of, one or more caller preferences, a set of non-personally identifiable information, a set of personally identifiable information, or a set of local audio playback information.
